(19) United States
(12) Patent Application Publication
(10) Pub. No.: US 2015/0245425 A1
(43) Pub. Date: Aug. 27, 2015

(54) SEMI-INSTANTANEOUS MICROWAVE-INDUCED THERMO HEATER

(71) Applicant: Diego José Correa Hidalgo, Puerto Del Rosario-Fuerteventura (ES)

(72) Inventor: Diego José Correa Hidalgo, Puerto Del Rosario-Fuerteventura (ES)

(21) Appl. No.: 14/431,117

(22) PCT Filed: Oct. 3, 2012
(86) PCT No.: PCT/ES2012/070686

§ 371 Date: Mar. 25, 2015

(51) Int. Cl. H05B 6/80; F24H 9/20; F24H 9/12; F24H 7/00

(52) U.S. Cl. CPC H05B 6/804; F24H 7/002; F24H 9/2021; F24H 9/124

(57) ABSTRACT

Thermo heater comprising: a tank (1) made of glass, fitted with a cover (7) and a number of magnetrons (3) supported by a belt or a support framework (2) surrounding the tank (1), which offer the magnetrons continued support and which may be arranged inside the tank (1). Each one of the magnetrons (3) is housed on a primary exchanger (5) and this, in turn, on the main exchanger (6). A solenoid (8) is arranged on the cover, as well as a support for a rod thermostat and the water inlets and outlets. A mixing valve (20) is arranged under the cover, connected by a regulator (17) with a cover and operated by means of a piston (15) connected to the solenoid. The mixing valve is a double filter valve. Thanks to the characteristics of the materials used, the following is achieved: almost instant heating, a reduction of energy consumption and effective protection against the proliferation of colonies such as legionella.

### OBJECT OF THE INVENTION

As the title of the present invention indicates, the object of the present invention is a semi-instant thermo heater induced by microwaves.

The heater, object of the present invention, is characterized by the combination of elements and materials from which it is made up, in such a way that a heater which gives rise to the water being heated up almost instantly is obtained, this heater also reducing energy consumption and ensuring efficient protection against legionella.

The present invention falls within the technical field of heating water by means of electrical energy, for domestic, industrial and business use.

### THE PRIOR ART

Various ways to heat up water currently exist. Hot water is used in showers and in all processes involving running water, where it is necessary to heat the water in order for it to be used.

Different means for heating water exist:
Accumulation boilers are most commonly used.
Point heaters, which involve a transfer method (without a tank), also exist.

A diverse range of energy sources are used, from gas and fossil fuels to solar and electric sources.

There are currently three main electric methods for heating water:
By means of “electrical resistance”, which may be carried out using a magnesium anode or using sealed thermal break (layers of porcelain means and an interior copper finishing).
By means of “electric coil”, an electrical break which surrounds a metallic tube, through which the water circulates.
And thirdly by means of a hybrid of the two previous methods.

The electrical break method is used in electric boiler systems in which the water is heated slowly and is kept this way in order to be used. Although the system is kept isolated, the internal break in contact with the water will operate constantly. This presents three main problems: firstly, it gives rise to an electrical consumption which is an inverse exponential of the water temperature and the exterior temperature, which secondly leads to the fact that it is thereby necessary to keep the water hot for and up until the moment it is used and thirdly, a significant amount of energy consumption expenditure is generated as a result, with measurements of 30% of electricity bills having been taken. Furthermore, they are contaminant materials which are difficult to recycle.

The water circulates and will be kept in watertight tanks, which although vitrified, are mainly made of metal.

The electrical consumption of heating coils is different, given that energy is only consumed when the water is heated. However, the energy expenditure needed to raise the water temperature instantly, in order for it to be used, results in a high exponent, which is reflected in the energy bill. Although they consume less energy, since they are precise they require higher power supply levels.

This results in greater energy expenditure and a disproportionate energy bill. Furthermore, they are usually easy to block, especially where hard water is concerned and are only recommended for temperate climates. The majority of them require triphasic connections.

The third model indicated, referred to as “semi-instant” and “ecological”, is a hybrid of the two previous models. However, these models are based on the electrical breaks system, which are necessarily shielded, in some cases up to 8000 Watts and the only improvement they give is their reduced size.

In addition, current boiler heaters are made of metal and undergo electrolysis. No matter how high the quality of the metal from which the boiler recipients are made from, they will lose electrons. Adding magnesium anodes to the heaters minimizes this, since magnesium is a metal which acts as a sacrificial anode when low electrical intensity is applied, i.e. to protect the boiler from oxidation. The problem arising from the use of these sacrificial anodes is that the disintegration salts of the magnesium anode are fuel for iron bacteria, just like any other oxide within the tank. These iron bacteria are the caviar of the legionella. If we add the fact that water transports earth and sludge to this process, the bacteria have a reservoir in which to develop. In order to prevent the formation of legionella colonies, it is necessary to increase the temperature of the water to above 70° C., because the bacteria develop into amoebas which refuge in the coldest part of a conventional heater, i.e. at the bottom, where the sludge accumulates and where the bacteria is able to survive insignificant contaminative hubs.

The object of the present invention is therefore to overcome the disadvantages mentioned, most importantly those related to electrical consumption and the formation of bacterial colonies such as legionella. It furthermore aims to offer more efficient after use recycling factor, by developing a boiler such as the one described below and contained within claim 1.

### DESCRIPTION OF THE INVENTION

The object of the present invention is a semi-instant thermo heater, in which heating is carried out by means of microwaves generated by a number of magnetrons, wherein the tank is also made of glass, a hygienic material which prevents the formation of bacterial colonies, wherein it also has a mixing valve, which carries out double filtering, thereby facilitating additional protection in the transfer of biofilms.

The thermo heater comprises:
A tank made of glass
A number of magnetrons mounted onto the tank and housed inside the same.
A tank closure and connection cover, where the connections for the control elements, such as the thermostat or a solenoid, as well as the water inlet and outlet connections are arranged. A double-filter mixing valve is arranged and mounted under the cover.

### Advantages of this Invention

Firstly, the thermo heater, object of the present invention, provides complete isolation of the electrical elements from the water circuit. In fact, the heat exchanger is the water itself.

In addition, the water will be heated by radio frequencies in an innocuous element, “a tank or boiler made of recycled glass”. Said boiler has a plastic cover with an internal conductive sheet, thus allowing plaque and residues to be cleaned from the tank, which would accumulate afterhours of use (it is important to note that water is loaded with different sediments, which is impossible to clean in other types of thermo heaters. It must also be understood that these types of particle, owing to the tank being made of glass, do not corrode or oxidize the walls thereof).

The tank is formed by two glass tanks in the form of a jar; an external tank and an internal tank, which are joined together, one fitting inside the other. They are separated internally by a double sheet of polyvinyl butyral or similar, leaving a laminate made of aluminum or a conductive material with perforations in the center. It is isotropic from its outermost laminate: glass, butyral sheet, aluminum or conductive metal, butyral and glass. This material has flexion capability, but strong durability when impacted.

A difference of very low intensity between the water and the conductive metal or aluminum sheet would detect cracks, closing the circuit.

Another advantage is its leak security system. The main function of the metal laminate is not only to synthesize the entire structure of the tank, but also to prevent radio frequencies of the microwaves, from leaking to the exterior through the interweaving of this metal grid, this being a security system against cracks.

Additionally, the fact that the material is not degenerative is an advantage i.e. the fact that oxides or emulsions do not exist means that the water does not replenish the sediments. It is washable, having a security system against cracks and water leaks.

Another advantage is complete electrical isolation, the shielding of the magnetrons being provided by porcelain elements. Advanced materials exist such as graphite compounds and silicon carbide, which facilitate maximum thermal exchange.

In addition, the mixing valve does not require a non-return system. The valves available on the market offer the possibility of mixing hot and cold water, but all are external to the water circuit, requiring a non-return system. They save energy, but in contrast, they may form a soup for cultivating legionella. In the case of the present invention, the valve is internal, is made of plastic or porcelain and does not have a return. It will be bathed by the microwaves, thereby saving energy without producing countermeasures as external valves do. The heat exchange is faster than in conventional heaters and has notable energy efficiency.

### Description of the Elements Forming the Design of the Present Invention

The magnetron: formed by two cadmium, neodymium or alloy magnets. They are subjected to extreme voltages in the order of 5,000 volts. This extreme voltage is, in fact, applied for no more than one micro second. It is discharged by a condenser which serves as the voltage doubler, although this small fraction of energy application lasts for one millionth of a second, repeated in cycles of milliseconds. The magnetron is constantly supplied with a voltage of around 2,000 volts. This is based on a circuit:
A transformer with a secondary element;
In a coil which multiplies the voltage received tenfold;
A rectifier diode;
And a condenser in series which effectuates the voltage doubling by means of accumulating charge.

The magnetron is constantly supplied in the circuit by the voltage delivered by the transformer. This heat is located in the resonant cavity, where this constant voltage is applied. The magnets must not reach Curie temperature as if they do, they will lose their magnetic capacity and will not force the electrons to circulate in a spiral between the cavitations of the cavity, nor will they produce microwave radio frequencies. The magnetrons are therefore cooled for this reason. The two systems currently used are driven by air: either a powerful fan extracts the heat which dissipates through flaps, cooling the resonant cavity, or water is used for cooling, wherein a small tube which surrounds the cavity and which drives the cooling at a variable flow rate.

This invention carries out cooling by induction. The resonant cavity is surrounded by two porcelain bodies which are sealed (screwed together) and become one body on their surrounding area. They have a high heat transfer capacity. Semi-elastic graphites are available on the market, that is to say, if the exchanger is laminated with these properties, they make the perfect contact. However, if it does not have sufficient elastic capacity, the contact with the magnetron is improved by means of a thermal resin; in this way, a heat exchanger between the magnetron and the water is achieved. This element, referred to as the “primary exchanger”, may be completely adapted, thus superseding the flaps element, which is a coolant system driven by air. In turn, the primary exchanger, with the magnetron, is enclosed within the secondary or main exchanger; improving contact. If necessary, this can also be done with heat-transferring resin. The function of the two exchangers is to form a solid body, a unit with high dissipating capacity which is housed internally, such as a frame in the tank of the water boiler, ensuring the water-tightness and isolation of the magnetron.

Main elements of the secondary exchanger:
A waveguide, four centimeters in length, the function of which is to conduct the radio waves from the magnetron. It is, in fact, a hollow cylinder, which protrudes from the secondary exchanger, made of porcelain; its interior is laminated with conductive material; it is closed with a transparent lens to microwaves (the entire body remaining watertight), positioning the antenna of the magnetron towards the center of the tank. Its length depends on the output and cycle of the magnetrons.

The tank, may be made of polymers, but will preferably be made of glass; it may be made of recycled glass owing to its function, in the form of a jar (a shape without profiles or angles is sought, having a mouth of approximately 20 cm wide, through which the interior may be accessed). It has variable capacity according to production needs or function, given the consumption of water; it is sandwich-type structure in shape. The layers are located according to their positioning from the exterior to the interior:
Layer of glass, shaped when warm under cooling impact
Polyvinyl butyral layer or similar
Perforated conductive sheet or metallic mesh, being the microwave screen.
Polyvinyl butyral layer or similar
Layer of glass, shaped when warm under cooling impact
According to the break and volume characteristics varying between 0.5 to 1 cm, the diameter and thickness of the walls is confined to the water storage capacity
The function of this element fulfills three functions:
   1^{st} it contains the radio frequencies, the metallic sheet screen prevents this;
   2^{nd} it is a synergetic material and has a high resistance coefficient
   3^{rd} when a crack is produced, the metallic mesh closes the circuit; this causes the entire system to shut down and to cool (avoiding possible explosion as is the case with other thermo heaters). In this device, the most dramatic measure would be a crack through which pressure is alleviated. In turn, this invention also has a relief valve adjustment. The above constitute additional security measures.

The laminate, or mesh is closed at the mouth-cover neck of the tank, This makes it possible for it to serve as a bridge to a centronics type terminal when closing the contact with the cover, transmitting information to an EPROM memory or a CPU terminal.

In turn, the cover has the thermostat and the cold water inlet valves and hot water outlet valves. Both connections are at the top of this thermo heater, facilitating the emptying of the heater to clean the tank. The cold water inlet is connected to a plastic tube, which in turn, is connected to a mixing valve, which has two inlets and one outlet. The mixing valve may be rotated, does not have a return and is completely mechanical. Said valve is integrated into the interior of the cover, which has three threaded connections:
The 1^{st} has a tube extending to the bottom of the tank, through which cold water is replaced;
The 2^{nd} is a tube which ends in the mixing part which is open at the hot water outlet. It is of the key variety, whereby when one flow opens the other closes. A rod which protrudes from this part and which crosses the cover, controls it from the exterior and is hermetic. This causes it to rotate in one direction, changing the possible mixtures. With this being the case, the outlet may be standardized, not exceeding 50° C. or a standard outlet temperature. However, it forces the system to operate at a standard required internal heating temperature. It is becoming internationalized, obliging countries such as Canada and France, to accept this regulation and to use thermostatic or mixing valves in thermo heaters.
The 3^{rd} is a mixed water outlet for use thereof.

This thermo heater allows the temperature of the water to be raised to 85 to 90° Centigrade, but even at lower temperatures such as 65° C., direct exposure is dangerous. This is why it has a mechanical stop which has a maximum mixture of cold water in the event of an electrical fault. The adjusting of the rod and the quantity of mixing is carried out externally, it being possible for this to be done manual or by a solenoid, controlled by EPROM. The internal thermostat detects the temperature, shutting down and turning on the system in order to maintain the temperature programmed in the device. In turn, the cover has a thermostat with digital information at its outlet. The system therefore has two thermostats and adjustment for these mechanisms; they are directly adjusted at the cover and inform the EPROM of the internal temperature of the water and of the temperature of the water which is circulating through the outlet tube.

The thermo heater system is based on heating by radio frequencies through microwaves. The system has two 1.2 kilowatt magnetrons and the total output of the two magnetrons is 2.4 KW. Each magnetron is located within its respective primary exchanger and each one within its secondary exchanger. The exchanger systems house the magnetrons within the tank itself, helping them to dissipate the high temperatures produced when the radio frequencies are emitted. However, the watt output of the magnetrons is variable in relation to the tank and the requirements it sets.

The energy production cost of one magnetron is no more expensive than that of a break. The breaks carry out a constant conduction process albeit more slowly, whilst the heat generated by the magnetrons is exponential. In turn, the breaks lose capacity the closer they get to critical heating points, in contrast to the magnetrons.

The electrical breaks treat the water as a thermal conductor, whilst the radio frequencies treat the water as an electromagnetic conductor with behavior of a conductor. The temperature of the water has a more homogenous coefficient and needs less energy to keep it at an ideal hot temperature within the water tank. The hotter the water molecules are, the more heat they absorb, therefore, if the critical point of radio frequency absorption (78.8°) is approached, there will be minimum exertion on the part of the microwaves, this being a contrast which is exponentially inverse to the electrical breaks.

In summary, a notable energy efficiency in favor of the magnetrons becomes apparent, in comparison to the electrical breaks and the heat from the exertion of the magnetrons is always transferred to the water.

A shielded cable which supplies the magnetrons exists, which is carried to another control box, where the high voltage transformer is housed, with an outlet to one or a number of condensers and a rectifier diode, which forms a bridge between the two magnetrons. The approach is to supply a different charge, instead of using a basic voltage doubling system, where the magnetron is considered to be constantly charging, converting this charge of about 30% into voltage alone. This charge is sent to a second condenser or directly to the second magnetron, which is connected inversely to the first magnetron, rectified by the inverse diode. The magnetron may be considered a condenser.

The system operates in an exemplary manner. The operating temperature of the magnetrons is stable; when exchanging its excesses with the water, it provides an example of imperceptible thermal modulation.

The waveguide is exemplary in its emission of radio frequencies, as at its basic level, it fulfills the principle of ideal operation in which air is a conductor and the water is the dielectric; this is achieved in the case of this system. The waveguide of this system is submerged in the water, which is the perfect example and virtually perfect in the case of a dielectric. This, in turn, means that all of the emissions, not only the direct emissions, are absorbed by the water, that is to say that maximally, unrectified electronic frequencies generates a transverse electric wave (TE) which significantly polarizes the water.

It is important to note that in other models such as microwave ovens, none of these peculiarities are found. In fact, these unrectified frequencies are returned to the system itself.

This new system connects two inversely charged magnetrons, one being positive and the other, negative. It is regarded as the ideal model as a result of not having any unspecified energy in the system. It operates at an ideal temperature and no microwave frequencies rebound from the magnetron. Thus, a substantially stable model is provided.

In conventional systems, the magnetrons must be constantly supplied with a variable voltage of around 30% of the system requirements. This charge is a base which is accrued from the delivery of the transformer and is added to the discharge from the condenser. Consequently, this results in a redundancy of parasitic charges or dummy load. In reality, the entire course of events in these systems does not allow these unstable currents to be calculated and for an inverse diode to be inserted to rectify them, making them useful to the system once again. In our system, all of the points are provided for inserting this inverse diode.

It is understood that the discharge flow of a magnetron is an anti-clockwise frequency, but synchronized with the second magnetron, which operates under a scheme of fixed magnetron discharges, not in volatile secondary discharge frequency as is the case in a microwave oven, that is to say, it always has the nominal supply value of a magnetron and this 30% of energy proves that a magnetron is not parasitized (is not stolen) from the magnetron in its shutdown cycle and delivered to the other magnetron prior to the initiation of its turning-on cycle. When rectified, this current will not impact against those supplied by the condenser and to the constant of the transformer, saving the transformer this 30% extra exertion. When these currents are rectified, it is estimated that these savings and stability values will be even greater.

The cover of the system has a multi-pin connector. This is connected to a similar cable and at the other end to an “EPROM” memory, which controls the entire system. Said EPROM processor controls all of the functions, receiving information from each of the processes within this invention: its supply is 9 to 12 or 24 volts according to the most appropriate methods. A second cable connects to the high voltage supply system to a fuse protector. The information may be displayed by means of LEDs or on a small information screen

[. . . ] Housing the water inlets and outlets, an adjustment for thermostat terminals and their electrical connections. A third tube sealed for possible leaks. The piston protrudes and may be is operated manually or by means of a solenoid.

External protection box: the tank and all the internal parts are covered with an exterior laminate made of synthetic foam in its internal part and a rigid laminate which reinforces, isolates and seals it, this being a protective surface, which, in turn, houses the electronics in control boxes isolated from the tank.

The isolating sheet may be made of various materials. The tank is fixed to the chassis by means of a plastic piece upon which it rests, which is, in turn, fixed by means of a belt on the tank which fixes it in place.

The doors of the heater: the heater has a door to allow access to its interior and to carry out tasks such as cleaning or repositioning replacement parts. It has a mechanically operated interrupter button, the function of which is to activate a safety circuit, which has a maximum charge break that discharges condensers. This mechanical safety function, in turn, serves as a supply interrupter for the entire system. The condensers should not maintain a charge during normal use and following any functional operation, they should be discharged as the system is connected to the earth and so this break, which provides a high level of safety, always discharges to the condensers even though the system is considered to be shut down.

The water may be controlled by creating the mixture from the heater itself, with the water exiting at the desired and controlled temperature without mixtures external to the heater. It is understood that the mixing key is a double filter for legionella and always allows the water to be delivered at the desired temperature. To this end, an electronic connector terminal is provided in an electrical connection tube, which has a direct connection to the EPROM. This connection makes it possible to carry out the temperature control outside the device. Whether it is a shower or bath terminal, this control renders the double hot-cold tubing unnecessary.

As a result of the electrical connection tubing which allows control to be carried out externally to the device, the following is achieved:
reduced risk of bacterial infection in the tubing,
the cold water is, in turn, treated,
When controlling the temperature from the shower, the temperature thereof will not vary when there is a requirement for water in the kitchen. The danger of burns is thus avoided. It is understood that it is the internal valve of the heater which provides the premixed water.

Toilets may have communication control in compliance with the European Regulation 852/2004. According to this law, “water at 82.2 is the best biocide”, without leaving any kind of contaminant residue. The toilet is connected by means of a Centronics cable to the heater which has an internal key within the tank which switches between two positions: one for loading the cistern and the other for flushing, thereby allowing disinfection to be carried out when necessary; the subsequent transport of water at a high temperature from the heater, and the easing of the thermal impact with cold water. These tasks may be carried out with circulatory shut-off keys for safety during the process.

### EXPLANATION OF THE FIGURES

FIG. 1 is a perspective view of the heater and shows how a magnetron is mounted thereon.

FIG. 2 is a lateral view of the thermo heater, object of the invention.

FIG. 3 represents the different layers which are used to construct the thermo heater tank.

FIG. 4 is a lower view of the cover in a with a detail of the edge thereof.

FIG. 5 is a perspective depiction of the cover.

FIG. 6 shows the cover of the tank of the thermo heater, wherein the solenoid has been separated.

FIG. 7 shows the cover in a lower view and its coupling to the mixing valve.

FIG. 8 shows the mixing valve in an explosive view.

FIG. 9 is another depiction of the mixing valve. p FIG. 10 shows the mixing valve with the access and outlet conduits thereof.

FIG. 11 shows a detail of the regulator.

FIG. 12 shows an electrical connections tube for controlling the device externally.

### PREFERRED EMBODIMENT OF THE INVENTION

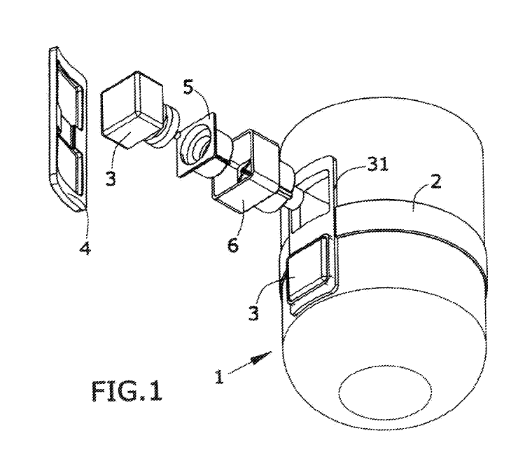

FIG. 1 shows a thermo heater like the one forming the object of the invention, which comprises:
a tank (1) made of glass
A number of magnetrons (3) supported by a belt or a support framework (2) which surrounds the tank (1) allowing the magnetrons to remain supported and which may be arranged inside the tank (1).

In turn, in order to fix the two magnetrons onto the belt or support framework (2), a unit defined by the following is used:

a plate or cover (4) which is fixed onto the belt (2), with openings over which the magnetrons (3) are passed and fixed, these magnetrons being fixed and secured on a primary exchanger (5) which envelops each magnetron like a glove, the primary exchanger (5) being introduced into a main exchanger (6) and welded to

a double joining wedge (31), which is a double portion that penetrates the tank (1) internally, supporting the main exchangers (6) and there being only one frame outside which protrudes and which is connected to the tank (1) and on which the tank belt (2) is supported and welded. The cover is fixed (4) on the exterior part of the double joining wedge (31) by means of a screw, this being a watertight unit.

Each one of the magnetrons (3) is housed in the interior space defined by a primary exchanger (5) and, in turn, this unit is housed within a main exchanger (6), both charged with cooling and exchanging the temperature reached by the magnetrons (3) with the water of the tank (1). Both the primary (5) and main refrigeration exchanger (6) carry out cooling; their contacts may be improved by using thermal resins. The contacts between both exchangers are improved using a number of superconducting thermal compounds with semi-elastic qualities such as graphite composite.

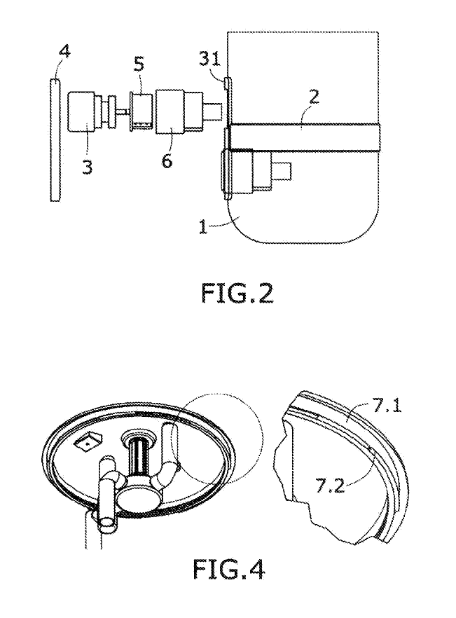

FIG. 2 is a lateral view of the previous depiction, in which one of the magnetrons, housed in the exchangers, is arranged on one of the cavities in the plate (4) and housed in the interior of the tank, whilst the other magnetron is shown separated from the exchangers which house it.

FIG. 3 shows different layers which serve to form the tank (1) where a primary layer or an exterior layer is a layer of glass (1.1) the exterior mouth of which is as wide as or wider than its base. This allows it to be demoded quickly and easily from the mold, which has a main mouth but another at its side for adjustment of the exchangers; this same adjustment makes it possible to move the tank, now freed from the mold, cooling it, thus resulting in warm glass, which is much stronger and more resistant to temperature cracks. A primary support gel (1.2) is then provided, followed by an aluminum sheet (1.3) which forms the screen for the microwaves. A second support gel (1.4) is then provided, followed by a smaller glass container (1.5).

The body is formed as an exterior and interior glass laminate and an aluminum screen separated from the two bodies made of glass by a polyvinyl butyral gel or similar.

The unit obtained in this way may be baked or injected cold by means of silicones, the aluminum screen blows like a flap above the other profiles protruding as a joining flap.

The closing belt (1.6) and the cover (7) are fitted on top of the other, this join being secured with a series of through bolts in the closing belt (1.6).

The aluminum profile is a grid type panel, however, the flap which protrudes is sealed and has a mounting frame. The closing belt (1.6) is adjusted, being closed with impermeable epoxies, with everything forming one single body after treating processes.

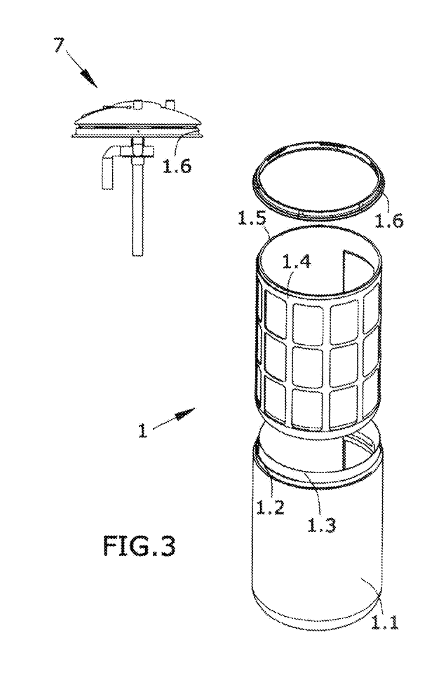

FIG. 4 shows the cover (7) of the tank which has a toothed closure (7.1) along its lower edge, associated with a seal closure (7.2), which allows the closure of the entire unit, secured by means of screws.

FIG. 5 shows the cover (7) of the magnetron, which comprises:
an outlet sealed to an expansion tank (10)
a water inlet (11)
a hot water outlet (12) along with an outlet of a contact for supplying the analogue or digital thermostat
an electrical supply contact (13), a multi contact
a solenoid (8)
a terminal (9) of a rod thermostat
A channel (14) for cabling, this channel (14) running between the electrical contact (13), the solenoid (8) and the terminal (9) of the rod thermostat.

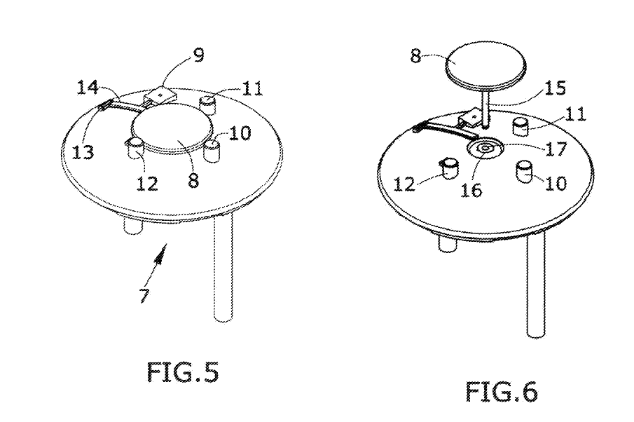

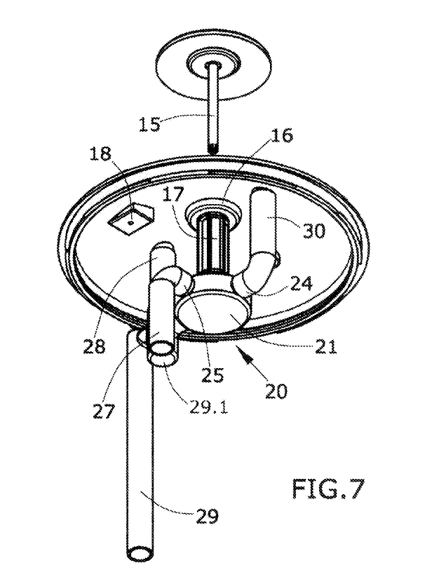

The solenoid (8) is a potentiometer which, in accordance with the application of electrical current, rotates in one direction or the other. Its function is to regulate the mixture of water which is carried out in the mixing key. The regulation of the mixture is carried out by means of a piston (15) (FIG. 6) connected at one end to the solenoid (8) and at the other to a mixing valve (20) (FIG. 7).

The solenoid (8) is electrically supplied from the electronic contact (13), with “Centronics” type cabling passing through the channel (14), which also carries the supply to an “EPROM” type memory (not shown).

FIG. 7 shows complementary elements mounted under the cover (7) of the tank (1). The presence of a support (18) for the thermostat connected externally in the terminal (9) should be pointed out. Under the cover (7), a support (16) for a regulator (17) is also provided which, at one end, is connected and threaded to the cover (7) by means of the support (16) and at its other end is threaded and connected to the mixing valve (20).

The support (18) of the thermostat protrudes in such a way that it is impermeable to the exterior, connected by the terminal (9) and allows the rod of the thermostat to be submerged in the hot water.

The function of the regulator (17) is to keep the piston (15) stable, which rotates internally by means of the regulator (17), making its operation watertight.

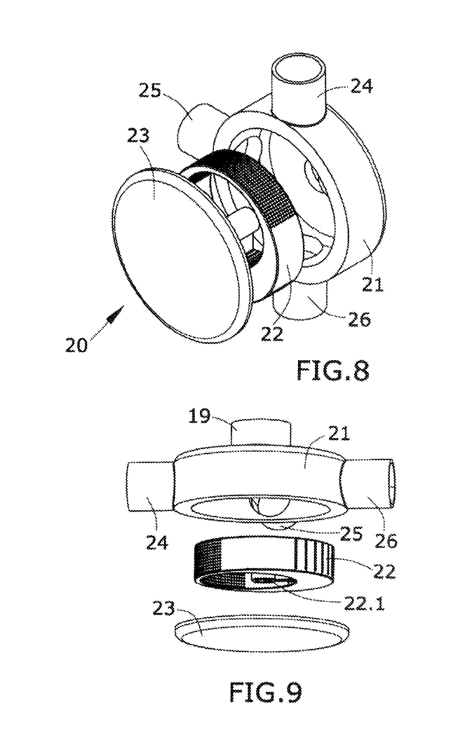

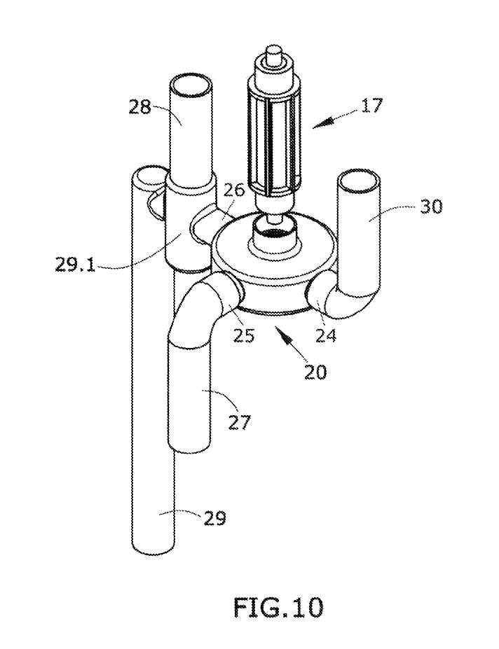

FIG. 7, just like FIG. 10, shows the mixing valve (20) mounted, whilst in FIGS. 8 and 9, it is dismounted.

The mixing valve (20) comprises:
an external control box which carries out the operations of the mixer (21), in the form of a cylinder open at one of its ends, whilst the other end has a threaded connection (19) (FIG. 9) for securing the regulator (17) and the course of the piston (15), which manages it,
A mixing disk (22) which acts as a filter and is housed in the interior of the mixing control box (21), the mixing disk remaining closed by a sealed closure (23).
Three connectors, where:
   One of the connectors is an outlet connector (24) for the mixed water, to which an outlet tube (30) (FIG. 7) is connected, which is connected to the hot water outlet (12) (FIG. 5).
   Another connector is an inlet connector (25) for the hot water to which is connected to the inlet tube (27) (FIG. 7) for the hot water.
   The final connector is a connection connector (26) to a dividing bypass (29.1) to which, on one side, a cold water tube (29) is connected, which passes through the interior of the tank until it almost reaches the bottom thereof, and on the other side, a tube (28) which is connected to the cold water inlet (11) (FIG. 5) is connected.

The mixing disk (22) is a hollow spherical cylinder and a principle axis with housing (22.1) for adjusting the piston (15). It has a multiple capillarity which interconnects the interior hollow and its exterior layer; the capillarity is divided into two different sections:
One with greater distribution and angle, which is always in contact with the outlet to the outlet connector for the mixed water.
The other section, according to whether it rotates right or left, is connected with greater capillarity to the connection (26) to the cold water inlet bypass or to hot water connector (25). This allows the flow, according to the rotation of said mixing disk, to vary the mixed water during mixing, when the capillary area is in greater contact with the bypass area or the cold area, the capillary contact with the hot water inlet connector reduces.

The mixing disk (22) rotates 90°, having various positions which mechanically allow closures, mainly of the outlet of the mixing water or closes the inlet of the hot water, only allowing cold water to enter, which exits directly though the outlet connector.

The double capillarity of the mixing disk fulfills the function of restricting the passage of biofilm, these organic particles are positioned so they face thermal impacts, breaking them up into vesicles which are the active form of legionella contagion. If they were allowed to pass unfiltered, they would arrive at the shower head where vesicles would leak little by little, however, if they are sieved, not allowing the passage of the particles, these will be attacked, not only by the thermal impact, but also by the TE (transverse electric) emission of radio frequencies by microwaves. These form covalences between the hydrogen atoms, breaking the chain of proteins in the bacteria. The filtering avoids their passage, giving the microwaves more time to destroy them.

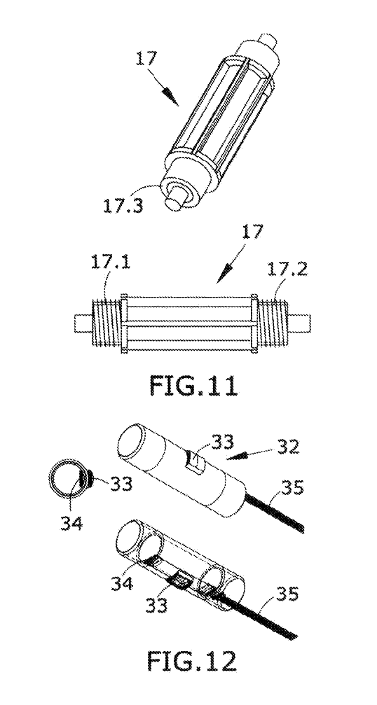

FIG. 11 shows the regulator (17), the two ends of which (17.1) and (17.2) are threaded for being secured onto the regulator support (16) and of the threaded connector support (19) of mixing control box (21).

FIG. 12 shows an electrical connections tube made of copper or plastic. After cutting a section of installed tube, it is threaded on both sides. The threading on both contacts is internal and external, therefore being adapted to tubing of 1 inch or ¾, the connection is inserted into the multiple connection terminals.

In the figure, it is possible to observe that it has a pin for internal connection (34) and another pin for external connection (33). These pins are all female. In total, each tube has four connections which are parallel—two internal and two external—grouped on a wall of the tube, allowing Centronic cables (35) of various pin terminals to be connected, although, standardized, carrying low voltage supply and digital information by means of the cold water tubes. The cable connections may be external or internal, bridging any obstruction as all are connected and therefore have shower to heater connections.

The connector terminal always remains outside the parts that rotate for coupling. This does not create any problems of strain for the cables. All of the terminals have a watertight threaded cover, when the connector of the cable is withdrawn, the conduction is sealed with screws and is watertight, a point welded with silicone reinforces these joints.

1. Semi-instant thermo heater induced by microwaves, characterized in that it comprises:
A tank (1) made of glass, fitted with an upper closing cover (7)
A number of magnetrons (3) arranged internally to a set of heat exchangers (5 and 6) supported by a belt or a support framework (2), which surrounds the tank (1), which allow the magnetrons to remain supported and which may be arranged in the interior of the tank (1), thereby cooling its operating temperature.

2. Semi-instant thermo heater induced by microwaves, according to claim 1, characterized in that , a unit is used to secure the magnetrons (3) onto the belt or support framework (2), which is defined by
a plate or cover (4), which when fixed onto the belt (2)has openings over which the magnetrons (3) are passed and fixed, these magnetrons being fixed and secured on a primary exchanger (5) which envelops each magnetron, each primary exchanger being introduced into a main exchanger (6) and which is welded to
a double joining wedge (31), which is a double piece that penetrates the tank (1) internally supporting the main exchangers (6) and there being only one frame outside, which protrudes and which is connected to the tank (1) and on which the tank belt (2) is supported and welded. The cover is fixed (4) on the exterior part of the double joining wedge (31) by means of a screw, this being a watertight unit.

3. Semi-instant thermo heater induced by microwaves, according to claim 1, characterized in that different layers which serve to form the tank (1) are as follows: a primary layer or exterior layer of glass (1.1), a primary support gel (1.2) then being provided, followed by an aluminum sheet (1.3) which forms the screen for the microwaves, a second support gel (1.4) then being provided, followed by a smaller glass container (1.5), formed like an exterior and interior glass laminate, an aluminum screen separated from the two bodies of glass by polyvinyl butyral gel or similar.

4. Semi-instant thermo heater induced by microwaves according to claim 6, characterized in that the cover (7) of the tank along its lower edge, has a toothed closure (7.1) associated with a seal closure (7.2), which allows the entire unit to be closed, secured by means of fixing screws.

5. Semi-instant thermo heater induced by microwaves, according to claim 1, characterized in that the cover (7) of the magnetron comprises:
an outlet to a sealed expansion tank (10)
a water inlet (11)
a hot water outlet (12)
an electronic supply contact (13)
a solenoid (8)
a terminal (9) of a rod thermostat
A channel (14) for cabling, this channel (14) running between the electrical contact (13) and the solenoid (8) and the terminal (9) of the rod thermostat.

6. Semi-instant thermo heater induced by microwaves, according to claim 5, characterized in that under the cover (7) of the tank (1) a support (18) is arranged for the thermostat, as well as a support (16) for a regulator (17) which is connected at one end to the cover (7) by means of the support (16) and at its other end is connected to a mixing valve (20).

7. Semi-instant thermo heater induced by microwaves according to claim 6, characterized in that the mixing valve (20) comprises:
a mixing control box (21) in the form of a cylinder open at one of its ends, whilst the other end has a threaded connection (19) for securing the regulator (17),
A mixing disk (22) housed in the interior of the mixing control box support (21), the mixing disk remaining closed by a closure (23).
Three connectors whereby:
One of the connectors is an outlet connector (24) for the mixed water, to which an outlet tube (30) is connected, which is connected to the hot water outlet (12).
Another connector is an inlet connector (25) for the hot water which is connected to the tube (27) of the hot water inlet.
The final connector is a connection connector (26) to a dividing bypass (29.1) to which a cold water tube (29) is connected at one side, which passes through the interior of the tank until it almost reaches the bottom thereof, and on the other side, a tube (28) which is connected to the cold water inlet (11) is connected.

8. Semi-instant thermo heater induced by microwaves, according to claim 9, characterized in that the mixing disk (22) is a cylinder with a spherical hollow and a main axis with housing (22.1) for adjusting the piston (15); it has a multiple capillarity which interconnects the interior hollow and its exterior layer, the capillarity being divided into two different sections:
One with greater distribution and angle, which is always in contact with the outlet to the outlet connector for mixed water.
The other section, according to whether it rotates right or left, is connected to a greater capillarity with the connection (26) to the bypass or (25) to the hot water inlet.

9. Semi-instant thermo heater induced by microwaves, according to any one of the previous claims, characterized in that the temperature control is carried out externally to the thermo heater by means of an electrical connections tube (32) which has at least one pin for internal connection (34) and at least another pin for external connection (33), wherein these pins are all female and grouped on a wall of the tube; allow Centronic type cables (35) of various pin terminals to be connected.
